(19) United States
(12) Patent Application Publication
(10) Pub. No.: US 2026/0366557 A1
(43) Pub. Date: Nov. 19, 2026

(54) INDICATIVE FASTENER

(71) Applicant: A. RAYMOND ET CIE, Grenoble (FR)

(72) Inventors: Manuel Gerard Martinez, Shelby Township, MI (US); Kevin Patrick Bond, Brownstown Township, MI (US)

(21) Appl. No.: 19/158,792

(22) PCT Filed: Feb. 21, 2024
(86) PCT No.: PCT/IB2024/051685

§ 371 Date: Aug. 21, 2025

Related U.S. Application Data
(60) Provisional application No. 63/447,394, filed on Feb. 22, 2023.

(51) Int. Cl. F16B 17/00

(52) U.S. Cl. CPC F16B 17/00; F16B 2200/95

(57) ABSTRACT

A fastener is configured to engage a receiving mount defining a push surface and includes a housing, a body, and a biasing element. The housing defines a longitudinal axis, an opening, a cavity, and a window, and includes a stop opposite the opening. The body is slidably disposed in the cavity and includes an engagement surface and an indicia element configured to indicate an assembly status of the fastener. The biasing element is configured to bias the body away from the stop and towards the opening along the longitudinal axis. The body is movable in the cavity between a disengaged position in which the indicia element is not visible in the window and an engaged position in which the indicia element is visible in the window to indicate an assembly status of the fastener.

### BACKGROUND OF THE INVENTION

The present invention relates to fasteners having features that indicate proper assembly or orientation of the fasteners relative to a structure to which the fasteners are attached.

In many industries, partial installation or improper location of a fastener can cause assembly issues, quality problems, and eventual system failure.

For example, in a variety of industries, cables and other elongated structures are routed through equipment, parts, and other spaces. In the automotive industry, a cable can be routed through a space within or adjacent a body panel, a floor panel, a dashboard, an engine bay, or vehicle cabin from one location to another. Typically, the cable is secured in a fixed position and location within the space, so it does not rub on or engage the panel or other parts within the space. To do so, many manufacturers and assemblers use a cable routing fastener so that part of the cable is retained by the fastener, and the fastener itself is further secured to the nearby panel. Multiple cable routing fasteners can be aligned with one another and mapped across one or more panels to selectively route the cable within the space.

A typical cable routing fastener has a head that projects from a base and a clip disposed opposite the head. The head can have a cable tie or clamp that directly engages and retains the cable, securing it to the base. The clip can be a canoe clip, pine tree clip, push pin or other structure that can project through a hole in a panel and adequately grip the panel to secure the cable routing fastener to the panel. As a result, the cable also is secured in a fixed position relative to the panel.

An issue with conventional cable routing fasteners is inadequate securement to the panel. In some cases, this can occur when the clip is not adequately engaged with the panel. For example, the clip can be partially inserted in a hole in the panel, but not sufficiently locked in the hole. After time, or upon further movement of the cable, the clip can disengage the hole, in which case the cable can separate from the panel and/or become improperly situated relative to other parts near the cable. In other cases, the cable routing fastener might not be oriented properly relative to the hole, and thus the panel, upon assembly to the panel. When this occurs, the improperly oriented cable can bind or kink, or generally not function properly. In yet other cases, the cable routing fastener might be broken if inserted in the hole or engaged with the panel incorrectly. In further cases, the cable routing fastener might only include a simple round clip which can spin or rotate in the hole. As a result, the cable can pivot or rotate about the hole, and thereby become improperly oriented relative to the space or other parts within the space. This can result in the cable being less than optimally routed.

When a cable routing fastener inadequately secures a cable to a panel or other structure, this defect might not be realized until well after assembly of the vehicle, machine or placement of nearby parts and structures. As a result, the cable routing fastener may be confined in a space that is difficult to access. Accordingly, to correct the defect or placement, parts near the fastener may need to be removed, which can consume time and cost money. Further, if the fastener fails while securing a critical cable, for example, one that operates a vehicle or machine, the function of that cable can be compromised. In turn, this could cause the machine or vehicle to malfunction, causing damage to the machine or vehicle, or injury to an operator thereof.

Accordingly, there remains room for improvement in the field of cable routing fasteners and confirming that those fasteners are properly installed and ready to function.

### SUMMARY OF THE INVENTION

A fastener is configured to engage a receiving mount and includes a housing defining a cavity, and a body which is slidably disposed in the cavity and having an indicia element is disclosed. The indicia element indicates an assembly status of the fastener, i.e., whether the fastener is properly installed on/secured to a workpiece.

As a first example, a fastener is configured to engage a receiving mount including a push surface. In this example, the receiving mount is configured to engage a workpiece. The fastener includes a housing defining a longitudinal axis, an opening, a cavity, and a window. The housing includes a stop opposite the opening. The fastener also includes a body slidably disposed in the cavity. The body includes an engagement surface and an indicia element configured to indicate an assembly status of the fastener. A biasing element is configured to bias the body away from the stop and towards the opening along the longitudinal axis. The body is movable in the cavity between a disengaged position in which the indicia element is not visible in the window and an engaged position in which the indicia element is visible in the window to indicate an assembly status of the fastener. When the housing is engaged with the receiving mount, the push surface of the receiving mount contacts the engagement surface of the body to move the body within the cavity from the disengaged position to the engaged position and expose the indicia element in the window and indicate that the fastener is properly installed on the workpiece.

In another example, a routing fastener is configured to engage a receiving mount including a push surface. In this example, the receiving mount is integral with a workpiece. The fastener also includes a housing. The housing defines an opening and an aperture, and includes a top wall, a bottom wall opposite of the top wall, and a stop opposite the opening. The fastener also includes a body. The body is slidably disposed in the aperture and includes an engagement surface, a biasing surface, and an indicia element that indicates a status of assembly of the fastener relative to the workpiece. A biasing element is configured to bias the body away from the stop and towards the opening. The body is movable in the aperture between a concealed mode in which the indicia element is not visible and an exposed mode in which the indicia element is exposed to the environment, where the housing must properly engage the receiving mount to move the body and indicia element thereon into the exposed mode. A user cannot expose the indicia element when the housing is not properly secured to the receiving mount.

A method of using a fastener is also disclosed. The fastener is configured to engage a receiving mount. The fastener including a housing defining a cavity and a window, a body slidably disposed in the cavity and including an indicia element that indicates a status of assembly of the apparatus relative to a workpiece, and a cable or tube connector is provided. The housing is secured to the receiving mount thereby moving the body relative to the housing along a path of movement. In turn, the indicia element is exposed in the window upon moving the body relative to the housing, having been concealed prior to the moving step. Once exposed, the indicia element is read.

With this fastener and method, a user can avoid improper installation relative to the workpiece. The cable or tube joined with the fastener thus can be secured well in its position and/or orientation. The cable or tube likely will not have to be later rerouted or fixed, nor will it interfere with other parts or components in the space in which it extends due to its proper attachment to the panel via the fastener. This can save resources, and avoid needless disassembly and reassembly of a vehicle, machine, or equipment to address a loose, misaligned, or misguided cable or tube therein.

These and other objects, advantages, and features of the invention will be more fully understood and appreciated by reference to the description of the current example and the drawings.

Before the examples of the invention are explained in detail, it is to be understood that the invention is not limited to the details of operation or to the details of construction and the arrangement of the components set forth in the following description or illustrated in the drawings. The invention may be implemented in various other examples and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various examples. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of an example of a fastener configured to engage a receiving mount and connect to a workpiece, the fastener including a housing defining a cavity, and a body slidably disposed in the cavity.

FIG. 2 is a perspective view of the fastener of FIG. 1 with the housing made transparent.

FIG. 3 is a partially exploded perspective view of the fastener of FIG. 1 with the body made transparent.

FIG. 4 is an exploded bottom perspective view of the fastener of FIG. 1.

FIG. 5 is an exploded top perspective view of the fastener of FIG. 1.

FIG. 6 is a perspective view of another example of a fastener configured to engage a receiving mount and secure to a workpiece, a housing defining a cavity and a window and having an indicia element, and a body slidably disposed in the cavity.

FIG. 7 is an exploded top perspective view of the fastener of FIG. 6 illustrating the receiving mount in yellow, the housing defining a window in blue, and the body in green including the black indicia element.

FIG. 8 is a perspective view of the fastener of FIG. 6 wherein the body is in a disengaged position in which the indicia element is not visible in the window.

FIG. 9 is a perspective view of the fastener of FIG. 6 wherein the body is in an engaged position in which the indicia element, illustrated in black, is visible in the window.

FIG. 10 is a perspective view of a preassembly of the fastener of FIG. 6 including the body disposed in the housing.

FIG. 11 is a perspective view of the fastener of FIG. 6 illustrating an attachment interface for securing part or assembly.

FIG. 12 is a perspective view of another example of a fastener configured to engage a receiving mount and connect to a workpiece, the fastener including a housing defining a cavity, and a body slidably disposed in the cavity.

FIG. 13 is a cross-sectional view of the fastener of FIG. 12 along line 13-13 illustrating the receiving mount having a push surface formed by a pair of ribs.

FIG. 14 is a cross-sectional view of the fastener of FIG. 12 along line 14-14 illustrating the receiving mount including a first and a second aperture and the housing including a corresponding first clip and a corresponding second clip, respectively, the first and second apertures and first and second clips configured to locate and secure the housing relative to the workpiece.

FIG. 15 is a perspective view of another example of a fastener configured to engage a receiving mount and connect to a workpiece, the fastener including a housing defining a cavity and a window, an indicia element, and a body slidably disposed in the cavity assembled and ready for use.

FIG. 16 is a cross-sectional view of the fastener of FIG. 15 along line 16-16 illustrating the body slidably disposed in the cavity of the housing.

FIG. 17 is an exploded view of the fastener of FIG. 15.

FIG. 18 is another perspective view of the fastener of FIG. 15 illustrating the body slidably disposed in the cavity of the housing.

FIG. 19 is a partial perspective view of the fastener of FIG. 15 engaged with a workpiece.

FIG. 20 is a cross-sectional view of the fastener of FIG. 19 along line 20-20.

FIG. 21 is an isolated view of the workpiece of FIG. 19.

FIG. 22 is a flow chart illustrating an exemplary method of using a fastener.

FIG. 23 is a flow chart illustrating an exemplary method of using a fastener for routing a cable or a tube.

### DETAILED DESCRIPTION

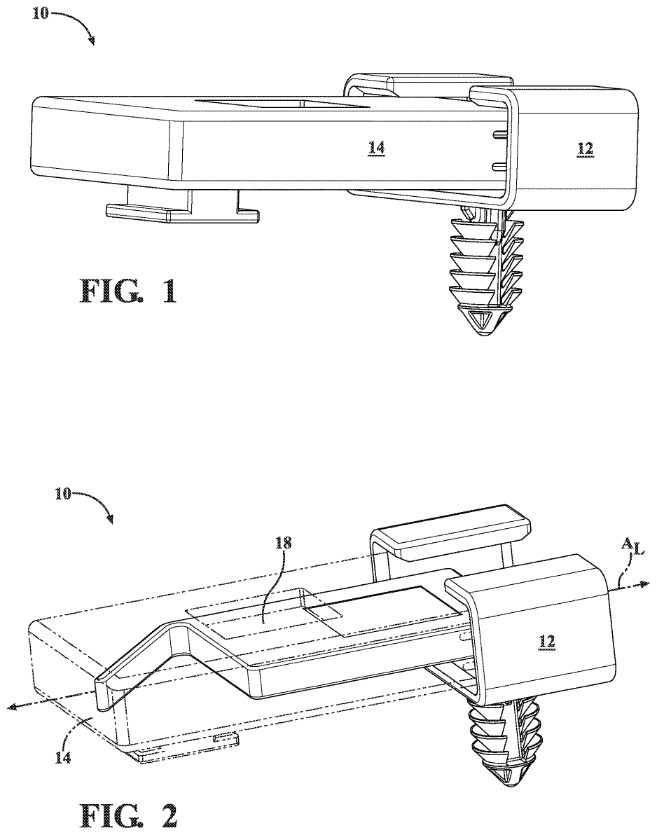

Examples of the fastener are shown in FIGS. 1-15 and generally designated 10/110/210. The fastener 10/110/210 is configured to engage a receiving mount 12/112/212 and includes a housing 14/114/214 defining a cavity 16/116/216, a body 18/118/218 slidably disposed in the cavity 16/116/216, and an indicia element 20/120/220. As is described below, the indicia element 20/120/220 indicates an assembly status of the fastener 10/110/210, i.e., whether the fastener 10/110/210 is properly installed or not. The fastener 10/110/210 can be referred to as an “indicative” fastener since it indicates installation status, i.e., provides an indication as to whether the fastener is installed to the workpiece properly or improperly. The fastener 10/110/210 is particularly effective in routing applications (e.g., cable and tube routing), but is not limited to use in routing applications and can be used with various parts and assemblies.

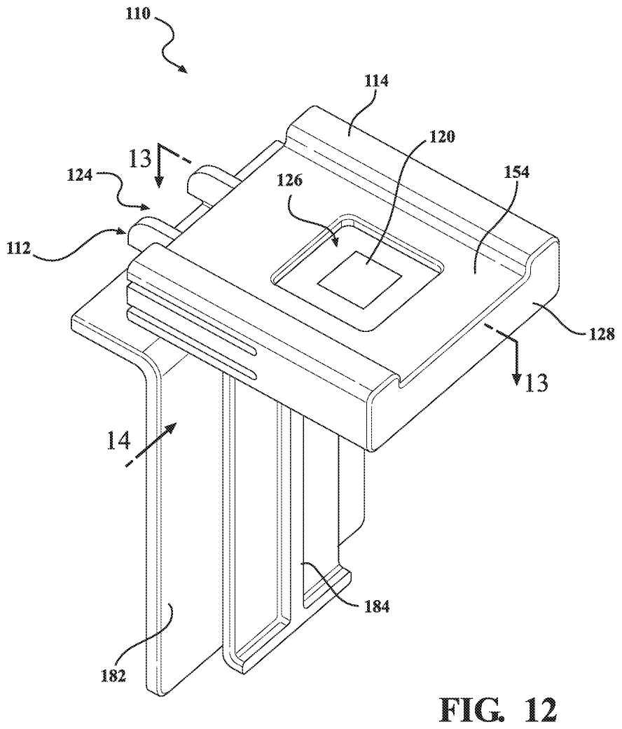

As discussed in the background above, in some situations, an operator can fail to install a prior art fastener, or an operator could partially install the prior art fastener which could lead to mechanical failure or other quality problems. In other situations, the operator could install the prior art fastener in the wrong location. As is explained below, the subject fastener 10/110/210 prevents such situations and, importantly, makes it difficult if not impossible for an operator to “trigger/show” the indicia element 20/120/210, e.g., a QR code, if the part is not installed, so the operator cannot scan the indicia element 20/120/220 to confirm proper installation without actually having achieved proper installation. Examples of the fastener are shown in FIGS. 1-11 and generally designated 10. The fastener 10 includes a receiving mount 12 configured to secure to a workpiece (not illustrated), a housing 14 defining a cavity 16, and a body 18 slidably disposed in the cavity 16 and having an indicia element 20. As is described below, the indicia element 20 indicates an assembly status of the fastener 10, i.e., whether the fastener 10 is properly installed or not. The example fastener 10 illustrated in FIGS. 1-11 includes the receiving mount 12, which is mechanically engaged with the workpiece. It should be appreciated that the receiving mount 12 can be mechanically fastened to, welded to, and/or bonded to the workpiece. The example fastener 10 of FIGS. 1-11 is essentially modular and offers great flexibility in how and with what it can be used since designs may on require minimal feature on the workpiece, e.g., a single aperture as illustrated. It should be appreciated that the receiving mount 12 can be mechanically fastened to, welded to, and/or bonded to the workpiece. Of course, as is discussed below with reference to FIGS. 12-21, the receiving mount 112, 212 can be integral with the workpiece 182, 282.

Referring now to FIGS. 1-21, the fastener generally is configured to mount to a workpiece (not illustrated). It will be appreciated that, as used herein, a workpiece also can refer to any type of panel, plate, pane, component, part, or other piece of a vehicle, machine, equipment, building or other structure. The workpiece can be disposed adjacent a space, which can be an open space without many other parts around it. Of course, in some applications, such as where the workpiece is a body panel, such as an interior of a fender, door, floor or other body panel, the space can be a small, confined space, with other parts, components, or elements of the vehicle projecting into the space. In these types of environments, the fastener 10 can assist in routing a cable and tube through the space and among the different parts in an organized and clutter free manner.

The panel can include or define an aperture. The aperture can come in a variety of shapes and sizes. For example, the aperture can be a circular, rectangular, square, polygonal, rounded or some other shape.

Referring now to FIGS. 1-5, the fastener 10 includes the receiving mount 12, which is configured to engage the workpiece. The receiving mount 12 includes a push surface 22. The fastener 10 also includes the housing 14 defining a longitudinal axis AL, an opening 24, the cavity 16, and a window 26. The housing 14 includes a stop 28 opposite the opening 24. In this example the stop 28 is an end wall of the housing. The fastener 10 also includes the body 18 slidably disposed in the cavity 16. The body 18 includes an engagement surface 30 and the indicia element 20 configured to indicate an assembly status of the fastener 10. A biasing element 32 is configured to bias the body 18 away from the stop 28 and towards the opening 24 along the longitudinal axis AL. It should be appreciated that the stop can be a plurality of ribs, a frame, or any shape sufficient to form a biasing surface upon which the biasing element 32 can engage. The body 18 is movable in the cavity 16 between a disengaged position in which the indicia element 20 is not visible in the window 26 and an engaged position in which the indicia element 20 is visible in the window 26 to indicate an assembly status of the fastener 10.

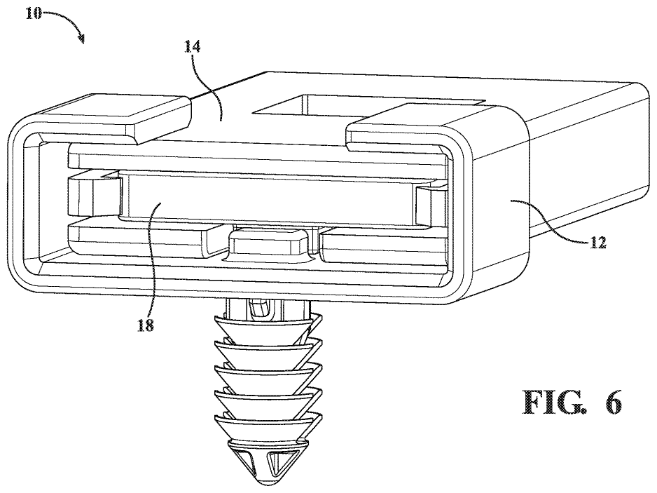

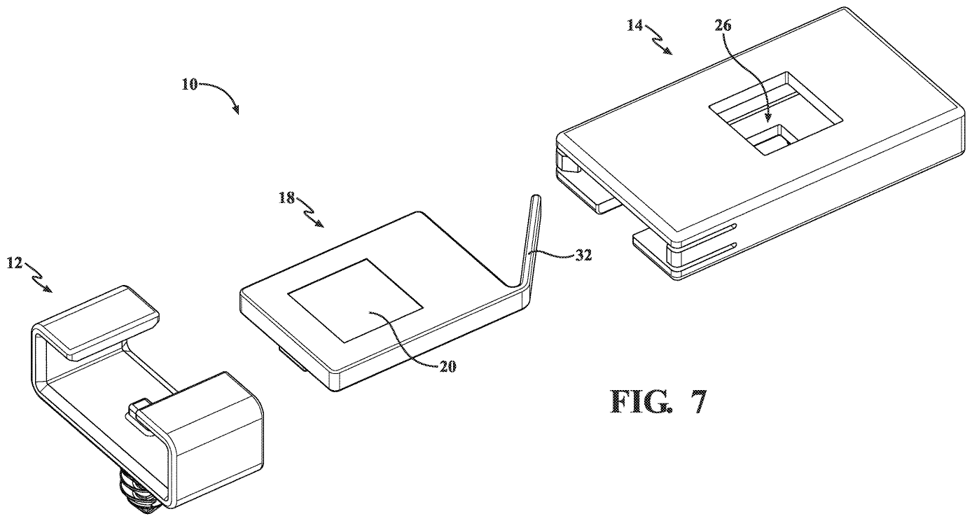

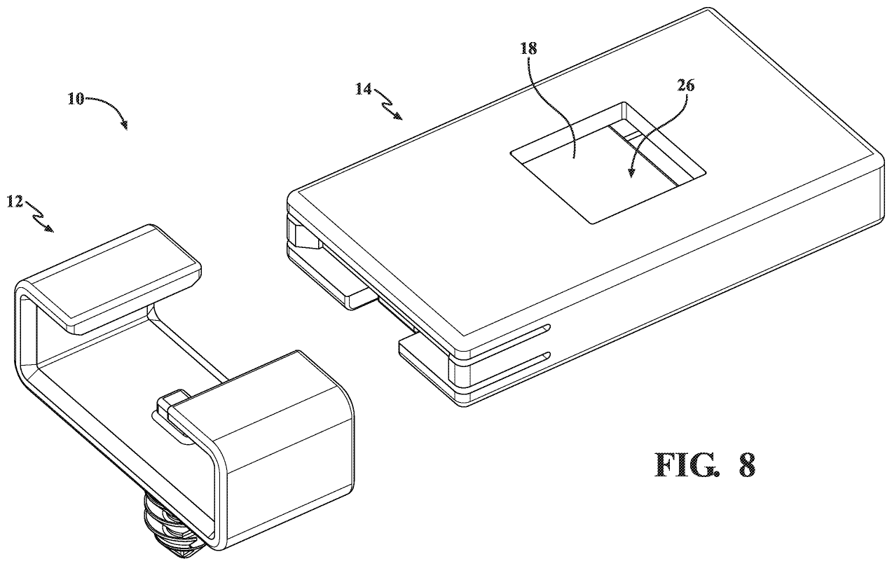

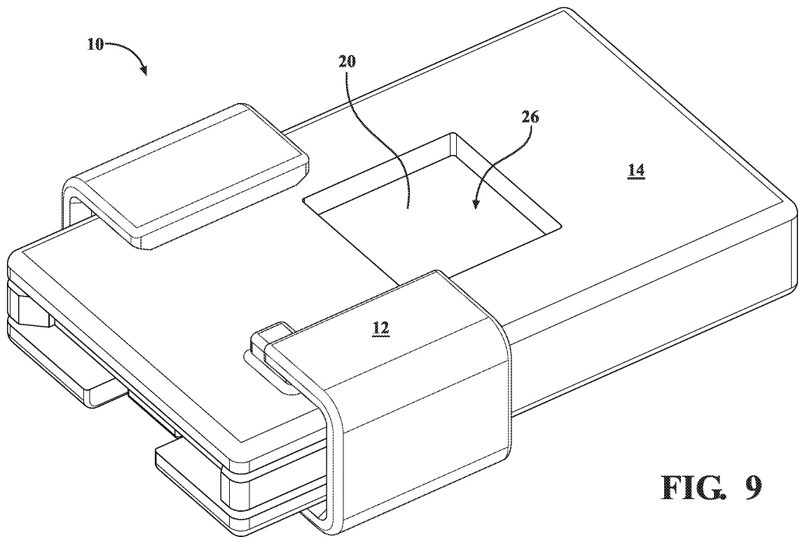

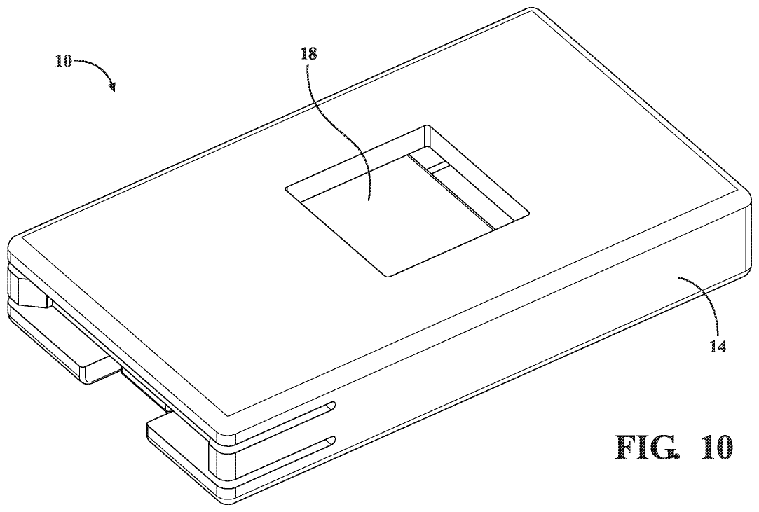

FIGS. 6-11 illustrate the fastener 10 including a receiving mount 12 configured to secure to a workpiece, a housing 14 defining the cavity 16 and the window 26 and having the indicia element 20, and a body 18 slidably disposed in the cavity 16. FIG. 6 is a perspective view of the fastener 10, while FIG. 7 is an exploded top perspective view of the fastener 10 of FIG. 6 illustrating the receiving mount 12, the housing 14, and the body 18 including the indicia element 20. FIGS. 8 and 9 illustrate the movement of the body 18 relative to the housing 14 within the cavity 16. More specifically, FIG. 8 is a perspective view of the fastener 10 wherein the body 18 is in a disengaged position in which the indicia element 20 is not visible in the window 26, whereas FIG. 9 is a perspective view of the fastener 10 wherein the body 18 is in an engaged position in which the indicia element 20, illustrated in black, is visible in the window 26.

Turning now to the structure of the fastener 10, the receiving mount 12, the housing 14, and the body 18 will be described in-turn in more detail.

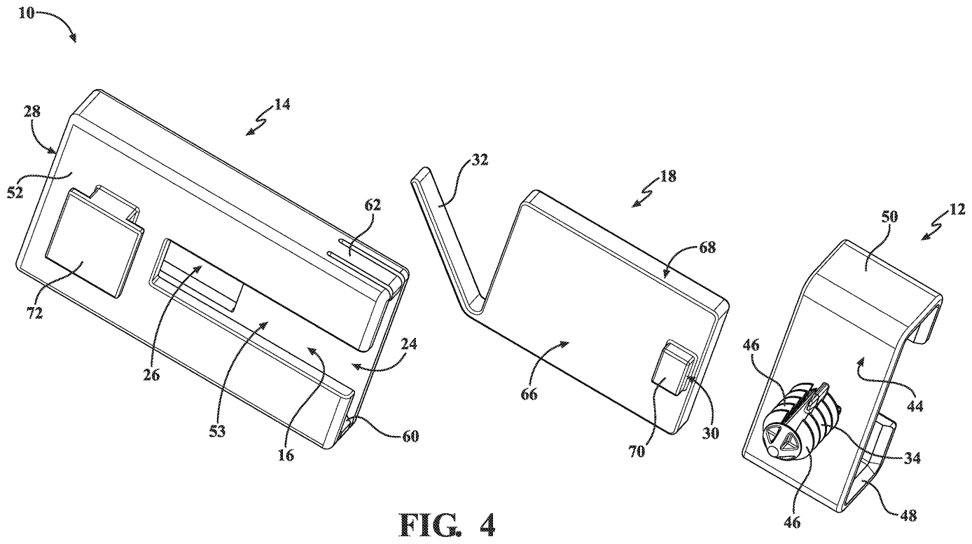

To begin, the receiving mount 12 is either integral with or configured to engage the workpiece and is also configured to secure or engage the housing 14 with the workpiece. The receiving mount 12 can be engaged with the workpiece mechanically (e.g., bolted, riveted, or engaged via other surface features which engage with corresponding features on the workpiece) or bonded (e.g., welded, adhesively bonded, etc.). Referring now to the example of FIGS. 1-3, the receiving mount 12 includes a first extension 34 resiliently extending therefrom and configured to engage a perimeter of an aperture in the workpiece. In this example, the receiving mount 12 includes a base 36 having a first end 38 and a second end 40 and defining a slide surface 42 opposite of a mounting surface 44. As is best illustrated in FIG. 4, the first extension 34 extends from the mounting surface 44 and includes a mounting interface 46, the mounting interface 46 is shaped to allow the mechanical fastening, welded, and/or bonding of the receiving mount 12 to the workpiece.

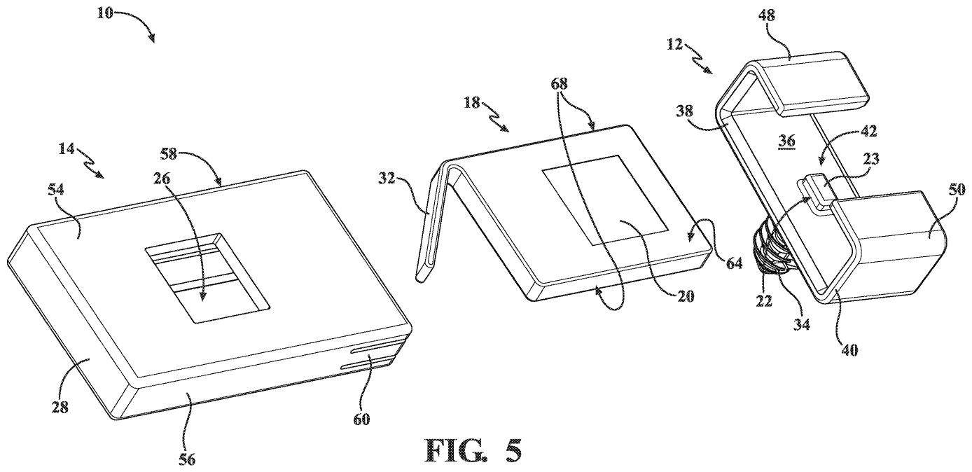

The mounting interface 46 can be a canoe clip, pine tree clip, push pin or other structure that can project through the aperture in the workpiece and adequately grip the workpiece to secure the fastener 10 thereto. The receiving mount 12 also includes a first arm 48 at the first end 38 of the base 36 and a second arm 50 at the second end 40 of the base 36. Referring now to FIGS. 6-8, the housing 14 is received by the slide surface 42, the first arm 48, and the second arm 50 and thus secured by the receiving mount 12. As is best illustrated in FIG. 5, a second extension 23 extends from the slide surface 42 and defines the push surface 22. From a functional perspective, when the housing 14 is slidably received between the first and second arms 48, 50, the push surface 22 of the receiving mount 12 is aligned with and contacts the engagement surface 30 of the body 18 to move the body 18 along the longitudinal axis AL within the housing 14 towards the stop 28 and expose the indicia element 20 in the window 26 and indicate that the fastener 10 is properly attached to the workpiece.

The housing 14 defines the longitudinal axis AL, the opening 24, the cavity 16, and the window 26. Plus, the housing 14 includes the stop 28 opposite the opening 24. In some examples, the housing 14 includes a bottom wall 52, a top wall 54 defining the window 26 opposite the bottom wall 52, a first sidewall 56, and a second sidewall 58 opposite the first sidewall 56. In some examples the housing 14 and/or the body 18 include a retaining or holding element to engage the body in the housing subsequent to assembly. In the example illustrated, the first sidewall 56 has a first clasp 60 and the second sidewall 58 has a second clasp 62, and the first and second clasps 60, 62 (collectively a holding element) are configured to engage and end surface and opposing side surfaces 68 of the body 18 (the contact points on the body 18 referred to as a retaining element). In other examples, the body 18 can include a retaining element(s) to engage a holding element(s) on the the housing 14. In some such examples, the bottom wall 52 defines a receiving slot 53 so that when the housing 14 is engaged with the receiving mount 12 and the push surface 22 of the receiving mount 12 is aligned with and contacts the engagement surface 30 of a guide 70 movement of the body 18 is guided and not restricted by contact between the guide 70 and the bottom wall 52.

As is best illustrated in FIGS. 4 and 11, the bottom wall 52 typically comprises an attachment interface 72. A cable or tube routing apparatus can be connected to the attachment interface 72. Of course, the subject fastener 10 is not limited to cable or tube routing apparatus. As such, various parts and/or assemblies can be connected to the attachment interface 72. The cable or tube routing apparatus or part can be attached to the fastener 10 mechanically. That is, the cable or tube routing apparatus or part can be attached to the fastener 10 via an attachment feature (as illustrated) on the fastener 10 which connects to a corresponding attachment feature (not illustrated) on the cable routing apparatus or part (not illustrated). The attachment interface 72 can comprise a mechanical interface and attachment via features including, but not limited to, clipping, bolting, and riveting. The attachment interface 72 can comprise a bonding interface and attachment via bonding including, but not limited to, adhesive bonding and welding.

In some of the example fasteners set forth herein, the receiving mount is integral with the workpiece. In these examples, the fastener includes at least one connector that is configured to engage the receiving mount to locate and secure the housing relative to the workpiece. The connector can be a canoe clip, pine tree clip, push pin or other structure that can project through the aperture in the workpiece and adequately grip the workpiece to secure the fastener 10 thereto. In a typical example, the connector is one or more clips configured to engage one or more apertures on the workpiece. Further, the fastener can include at least one locator that is configured to engage the receiving mount to locate and secure the housing relative to the workpiece. For example, the locater can be a pin configured to engage an aperture on the workpiece. As is described below, the bottom wall of the housing can comprise an attachment interface or locating extension, which can include the at least one connector, the locator, and/or a cable or tube routing apparatus.

The mounting interface 46 can be a canoe clip, pine tree clip, push pin or other structure that can project through the aperture in the workpiece and adequately grip the workpiece to secure the fastener 10 thereto.

Optionally, the fastener 10 can include a cable connector. This cable connector can be in the form of a cable tie. The cable connector alternatively can be in the form of a clamp, C-clip, hook and loop strap, tape strap, band, or other structure to connect the cable to the fastener 10. The cable connector can include a swivel post, to which a tie can be pivotally joined. In other applications, the cable connector can be void of a swivel. Although shown as projecting from the plate, the cable connector can extend from the body 18, or in some limited applications, might be joined with a part of the cover or can interface with the cover. A variety of other cable connectors are contemplated.

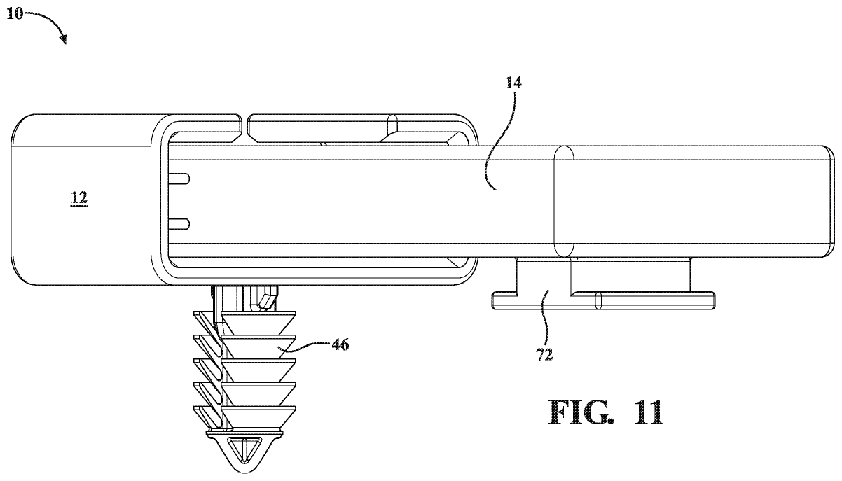

Of course, the body 18 is slidably disposed in the cavity 16 that is defined by the housing 14. During assembly, the body 18 is inserted through the opening 24 of the housing 14 and into the cavity 16. FIG. 10 shows a preassembly including the body 18 disposed in the housing 14. The body 18 includes the engagement surface 30 and the indicia element 20, which is configured to indicate an assembly status of the fastener 10. In a typical example, the body 18 includes a first surface 64 with the indicia element 20 thereon, a second surface 66 opposite the first surface, and the pair of side surfaces 68.

In some examples, the body 18 includes the biasing element 32. As is best illustrated in FIG. 2, the biasing element 32 is configured to bias the body 18 away from the stop 28 and towards the opening 24 along the longitudinal axis AL. In an example such as this, the biasing element 32 is positioned between a biasing surface 33 of the body 18 and the stop 28 of the housing 14. In this particular example, the biasing element 32 is a resilient arm extending from the biasing surface 33 of the body 18. Of course, the biasing element 32 can be a resilient loop having different shapes such as an X-shape, an accordion shape, a quadrilateral (e.g. diamond) shape, pentagonal shape, a circular shape, a semi-circular shape. The biasing element 32 can comprise two or more resilient arms (e.g. in a zig zagging or other configuration), etc. In the example illustrated, the biasing element 32 is integral with the body 18. In other examples, the biasing element 32 is integral with the housing. In still other examples, the biasing element 32 can be a stand-alone element such as a spring, and not be integral with either the housing 14 or the body 18.

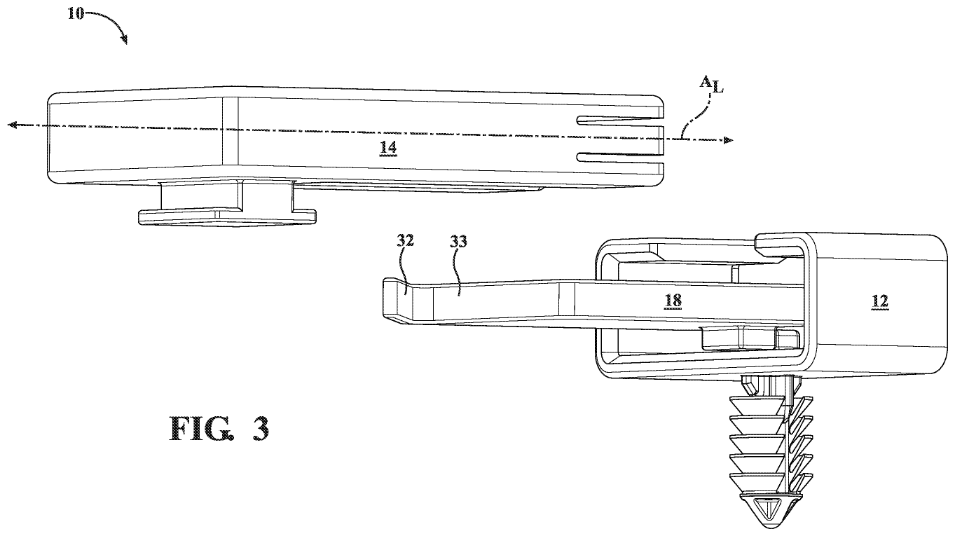

As is set forth above, the body 18 is movable in the cavity 16 of the housing 14 between a disengaged position in which the indicia element 20 is not visible in the window 26 and an engaged position in which the indicia element 20 is visible in the window 26 to indicate an assembly status of the fastener 10. From a functional perspective, a user engages the receiving mount 12 with the workpiece and engages the housing 14 with the receiving mount 12. As force is applied and engagement occurs, the push surface 22 of the receiving mount 12 contacts the engagement surface 30 of the body 18 (as is illustrated in FIG. 3) to move the body 18 within the cavity 16 from the disengaged position to the engaged position and expose the indicia element 20 in the window 26 and indicate that the fastener 10 is properly attached to the workpiece.

As is best illustrated in FIGS. 3 and 4, the body 18 typically includes a guide 70 extending from the second surface 66. The guide 70 defines the engagement surface 30. Of course, the push surface 22 of the receiving mount 12 aligns with and contacts the engagement surface 30 of the body 18 to move the body 18 along the longitudinal axis AL within the housing 14 towards the stop 28 and expose the indicia element 20 in the window 26 and indicate that the fastener 10 is properly attached to the workpiece.

In many examples, the body 18 includes the first surface 64 with the indicia element 20 thereon. The indicia element 20 can be read by a reader, and the proper installation and/or assembly of the fastener 10 relative to the workpiece can be recorded or otherwise input as data and stored in an associated storage media or memory. Typically, the indicia element 20 indicates the assembly status of the fastener 10, that is, whether it is properly assembled or installed or not, and thus, in some examples, whether attachment of the cable or tube to the workpiece will likely succeed or not.

The indicia element 20 may comprise a machine-readable optical indicator. More specifically, the indicia element 20, 120, 220 can be in the form of a data matrix or bar code, such as QR codes, UPC codes, EAN codes, or an RFID tag, alphanumeric element, or other type of identifiers, information conveyance elements or data storage articles. Where the indicia element 20 is in the form of an RFID tag, the fastener 10 can include some additional shielding, for example, in the top wall 54 of the housing 14, to isolate and/or block the RFID tag so that it cannot be read when the indicia element 20 is in concealed mode. The indicia element 20 can be visible and/or readable by a human user or a type of reader, which can store, transmit or otherwise manipulate signals relating to the indicia element 20. For example, the indicia elements 20 can be read by a barcode reader and/or an RFID tag reader. The reader can capture, store, transmit and/or receive signals, information and/or data related to the indicia element 20 when it is read. In some cases, the reader can be connected to a network, server, computer, or other device that compiles a status checklist for assembly of one or more of the fasteners 10 relative to one or more panels or other structures in a vehicle, machine, or equipment. Unless and until the indicia element 20 on a particular fastener 10 is read, that fastener 10 may be indicated on a display or other output as insufficiently installed relative to the panel. Optionally, in simpler manufacturing protocols, the indicia element 20 can be a sticker that is colored or includes an alphanumeric element that a user visually observes before confirming that the fastener 10 is adequately installed relative to the workpiece and/or the hole to ensure that the cable or tube likewise can be properly installed to complete the assembly. For example, the indicia element 20 can simply comprise a colored indictor, e.g., a green indicator. In such an example, the user gets a “green light” to proceed knowing that the fastener 10 is installed properly.

The indicia element 20 can be in the form of a sticker or thin placard that is disposed on the first surface 64. Of course, in other applications, the indicia element 20 can be a barcode that is affixed to or engraved on the top surface of the body 18. Optionally, in other applications, the indicia element 20 can be secured to the body 18 in another location, or other portion of the fastener 10.

Referring now to the fastener 110 of FIGS. 12-14, the receiving mount 112 can be integral with a workpiece 182. The fastener 110 is configured to secure to the receiving mount 112 and includes the housing 114 defining the cavity 116, and the body 118 slidably disposed in the cavity 116, and the indicia element 120. As is described below, the indicia element 120 indicates an assembly status of the fastener 110, i.e., whether the fastener 110 is properly installed or not. It should be appreciated that the housing 114 defining the cavity 116, and the body 118 slidably disposed in the cavity 116 and having the indicia element 120 can be just as described above with respect to both design and function.

Still referring to the fastener 110 of FIGS. 12-14, the receiving mount 112 being integral with a workpiece 182 means that the workpiece 182 is formed with one or more features that are collectively referred to as the receiving mount 112. These one or more features can perform the function of (1) locating the fastener relative to the workpiece 182; (2) securing the fastener to the workpiece 182; and (3) engaging the engagement surface 130 of the body 118. The example fastener 110 of FIGS. 12-14 utilizes one or more features and does not require a stand-alone receiving mount and can thus be economical and efficient in use.

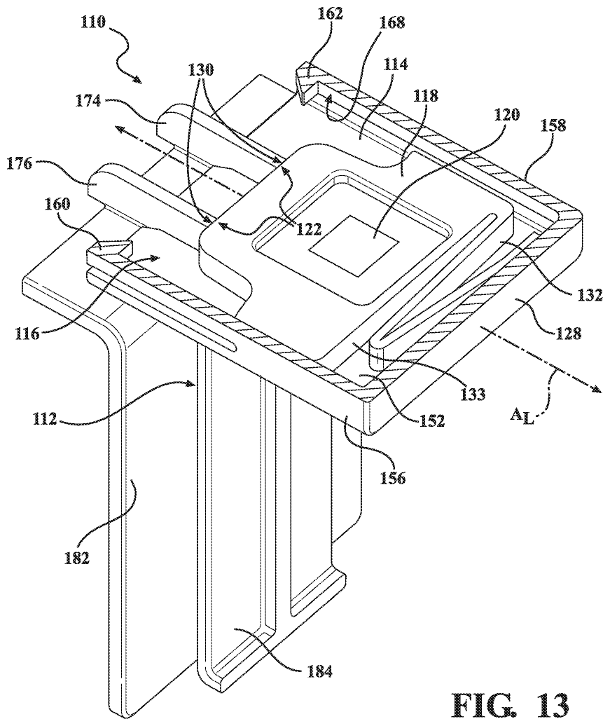

Referring now to FIG. 12, a perspective view of the fastener 110 including the receiving mount 112 integral with a workpiece 182, the housing 114 defining the cavity 116, and the body 118 slidably disposed in the cavity 116 is illustrated. In the example, the receiving mount 112 includes a push surface 122, which is defined by a first rib 174 and a second rib 176 and also includes a first aperture 178 and a second aperture 180 to properly locate the housing 114. FIG. 13 is a cross-sectional view of the fastener 110 of FIG. 12 along line 13-13, which illustrates the receiving mount 112 having the push surface 122 formed by the first and second ribs 174, 176. The push surface 122 of this example being formed from a first and second sub surface created by the first and second ribs 174, 176. It should be appreciated that the features are not limited to a pair of apertures and two ribs defining the push surface. For example, location and attachment could occur with 1, 2, 3, or more mechanical features and instead of a pair of ribs, a wall could define an unbroken (not segmented) push surface.

In FIG. 13, the housing 114 includes a bottom wall 152, a top wall 154 defining the window 126 opposite the bottom wall 152, a first sidewall 156, and a second sidewall 158 opposite the first sidewall 156. In this example, the housing 114 and/or the body 118 include a holding feature/element or features to engage the body 118 in the housing subsequent to assembly. In this example, the side surfaces 168 on the first and second sidewall 156, 158 of the housing 114 include a first and a second clasp 160, 162 (collectively referred to as a holding element) that engage the body 118 (at contact points on the body referred to as a retaining element) to retain the body 118 in the housing 114.

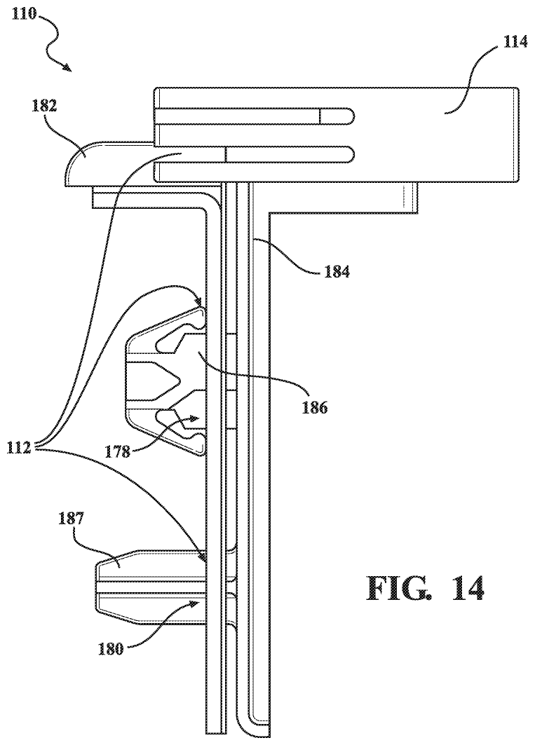

FIG. 14 is a cross-sectional view of the fastener 110 of FIG. 12 along line 14 -14 illustrating the receiving mount 112 including the first and second apertures 178, 180 and the housing 114 including a locating extension 184 having a first clip 186 and a locating post 187, which correspond with/are configured to align with the first and second apertures 178, 180 on the workpiece 182 to locate and secure the housing 114 relative to the workpiece 182. In this example, localization is achieved by the fastener 110 itself.

From a functional perspective, just like the first example fastener 10, when the housing 114 is received by the receiving mount 112, the push surface 122 of the receiving mount 112 is aligned with and contacts an engagement surface 130 of the body 118 to move the body 118 along the longitudinal axis (not illustrated) within the housing 114 towards a stop 128 and expose the indicia element 120 in a window 126 and indicate that the fastener 110 is properly attached to the workpiece 182. A biasing element 132 is configured to bias the body 118 away from the stop 128 and towards an opening 124 along the longitudinal axis. In this particular example, the biasing element 132 is a resilient arm including two segments and an elbow extending from the biasing surface 133 of the body 118. The body 118 is movable in the cavity 116 between a disengaged position in which the indicia element 120 is not visible in the window 126 and an engaged position in which the indicia element 120 is visible in the window 126 to indicate an assembly status of the fastener 110.

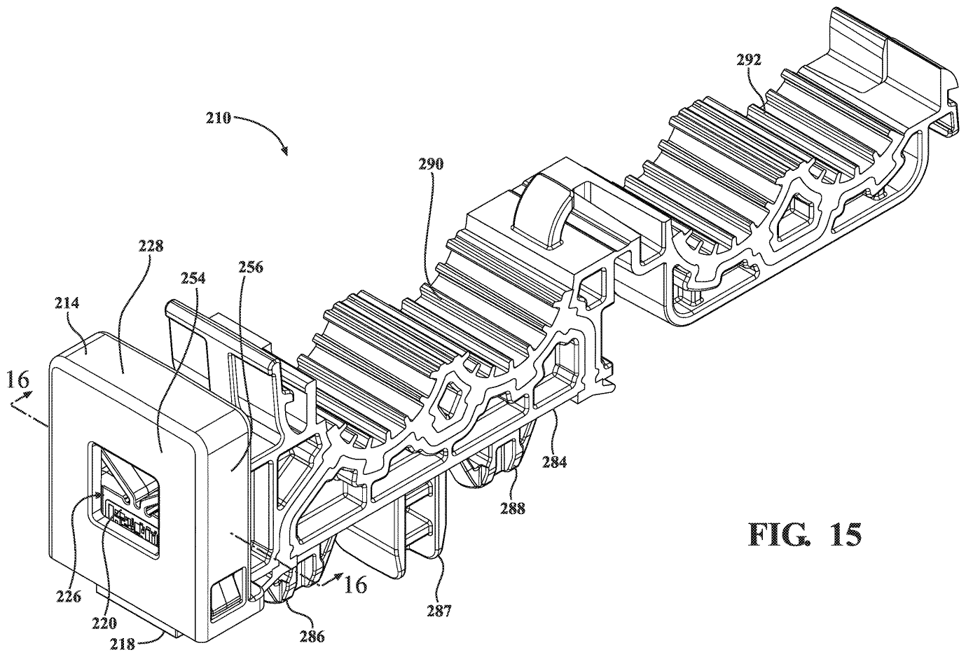

Referring now to a fastener 210 of FIGS. 15-21, a receiving mount 212 is integral with a workpiece 282. FIG. 15 provides a perspective view of the fastener 210 assembled and ready for use. The fastener 210 includes a housing 214 defining a cavity 216, and a body 218 slidably disposed in the cavity 216 and having an indicia element 220. As is described below, the indicia element 220 indicates an assembly status of the fastener 210, i.e., whether the fastener 210 is properly installed or not. It should be appreciated that the housing 214 defining the cavity 216, and the body 218 slidably disposed in the cavity 216 and having the indicia element 220 thereon can be just as described above with respect to both design and function. The housing 214 includes the stop 228 opposite the opening 224, a bottom wall 252, a top wall 254 defining the window 226 opposite the bottom wall 252, a first sidewall 256, and a second sidewall 258 opposite the first sidewall 256.

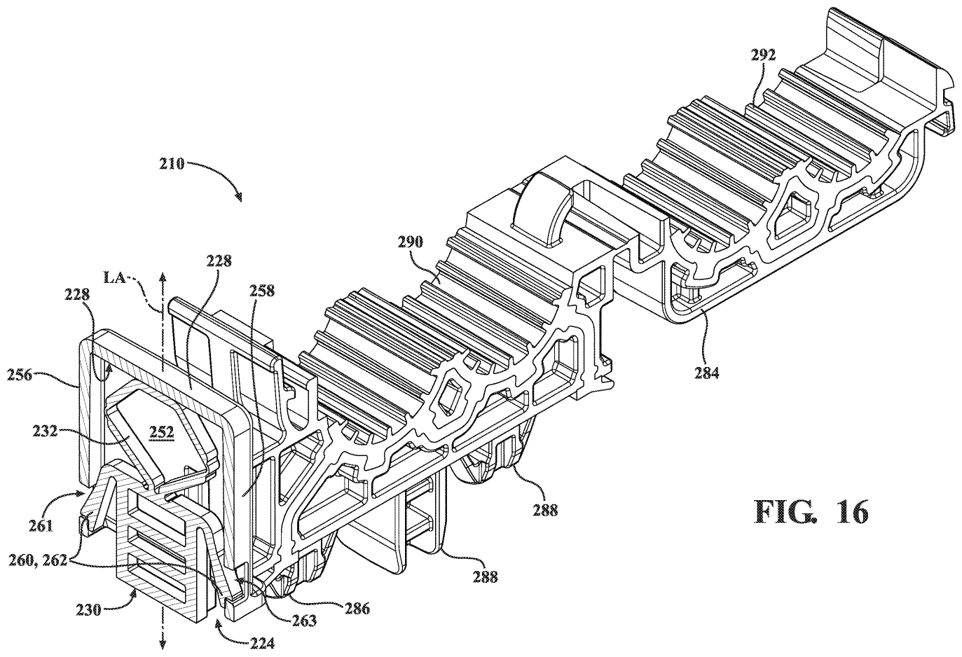

From a functional perspective, just like the previously described fasteners, when the housing 214 is received by the receiving mount 212, a push surface 222 of the receiving mount 212 is aligned with and contacts an engagement surface 230 of the body 218 to move the body 218 along a longitudinal axis defined by the housing 214 towards a stop 228 and expose the indicia element 220 in a window 226 and indicate that the fastener 210 is properly attached to the workpiece 282. A biasing element 232 is configured to bias the body 218 away from the stop 228 and towards an opening 224 along the longitudinal axis. In this particular example, the biasing element 232 extends from the biasing surface 233 of the body 218 towards the stop 228. FIG. 16 is a cross-sectional view of the fastener 210 along line 16-16. FIG. 16 illustrates the body 218, which is movably disposed in the cavity 216, in a disengaged position, with the biasing element 232 biasing the body 218 away from the stop 228 and towards the opening 224 along the longitudinal axis. In this example, the biasing element 232 has a pentagonal shape. As is described above, the body 218 is movable in the cavity 216 between the disengaged position illustrated in FIG. 15 in which the indicia element 220 is not visible in the window 226 and an engaged position in which the indicia element 220 is visible in the window 226 to indicate an assembly status of the fastener 210.

Generally, the body has a retaining element, and the housing has a corresponding holding element that cooperate to retain the body in the housing once the fastener is in an assembled state, e.g. the body is inserted in the housing. In the example fastener 210 illustrated in FIG. 16, the body 218 includes a first clasp 260 and a second clasp 262 (collectively the retaining elements). These first and second clasps 260, 262 are configured to engage respective notches 261, 263 (collectively the holding elements) on opposing inner surfaces of the housing 214. This configuration is different than (opposite of) the configuration described above with reference to the example of the fastener 10, wherein side surfaces 68 of the housing 14 include a first and a second clasp 60, 62 that engage the body 18. In the other examples described herein various clamping mechanisms known in the art can be employed as the retaining element on the body 218 and the holding element on the housing 214 so that they can are engaged in assembled state, which provides a consistent, user-friendly assembly that is connected when accessed by an operator prior to attachment to the workpiece 282.

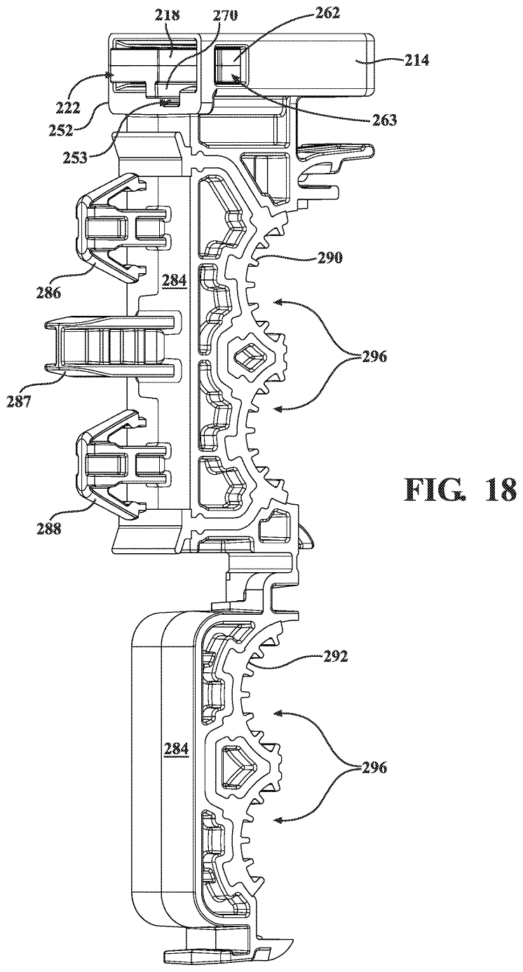

In this example of the fastener 210, as is best illustrated in FIG. 18, a bottom wall 252 of the housing 214 defines a receiving slot 253 so that when the housing 214 is engaged with the receiving mount 212 and the push surface 222 of the receiving mount 212 is aligned with and contacts the engagement surface 230 and a guide 270 extending on the body 218 moves within the receiving slot 253 of the housing 214 to guide movement of the body 218 within the housing 214.

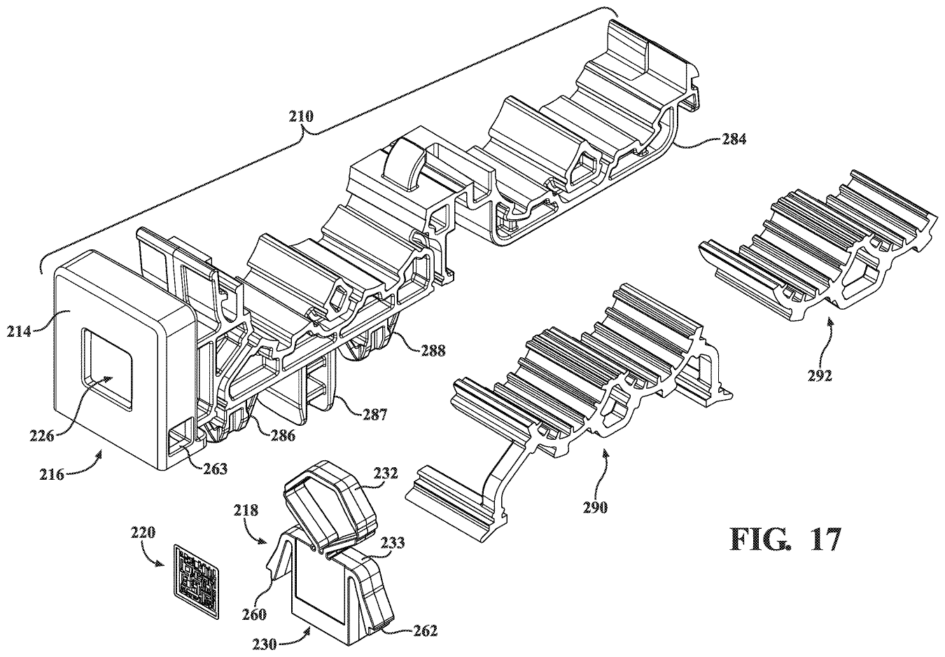

FIG. 17 is an exploded view of the fastener 210 of FIG. 15. The fastener 210 includes the housing 214 and a locating extension 284 having a first clip 286, a locating post 287, and a second clip 288. The indicia element 220, which is illustrated separately from the body 218 can be mechanically affixed to, or adhered to the body 218. In other examples, the indicia element 220 is not a separate piece and is simply printed on, etched on, or engraved on the surface of the body 218. Of course, the indicia element 220 may be a colored indictor or text readable by a person or machine. In some examples, the indicia element 220 is a bar code, a data matrix code, a QR code, UPC code, EAN code, or an RFID tag, alphanumeric element, or other type of identifiers, information conveyance elements or data storage articles. Various descriptions of the indicia element and means for providing the indicia element are described elsewhere herein.

Also illustrated in FIG. 17 are two routing liners 290, 292, which are formed separately and at least partially define a plurality of routing orifices 296 (e.g. 2, 3, 4, 5, or more). In this example, the two routing liners 290, 292 are over molded into the locating extension 284. Alternatively, these routing liners 290, 292 could also be co-molded with the housing 214 and the locating extension 284. In some embodiments, the routing liners 290, 292 are welded to, adhered to, or mechanically attached to the locating extension 284.

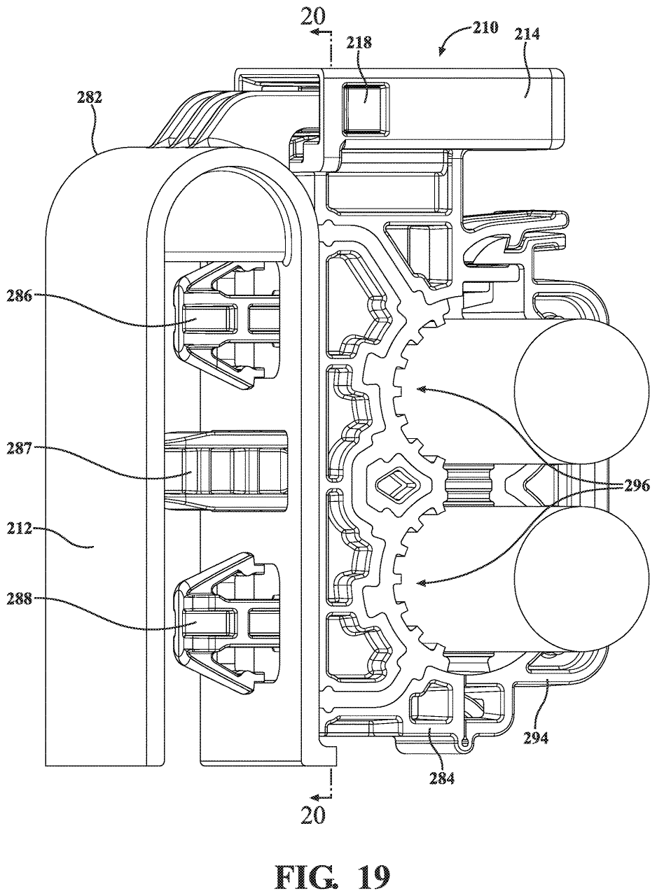

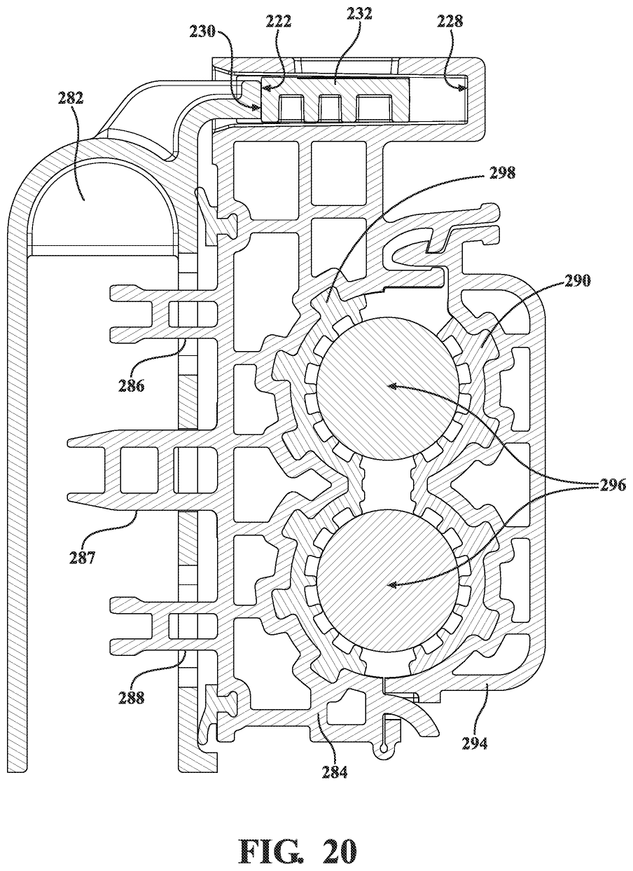

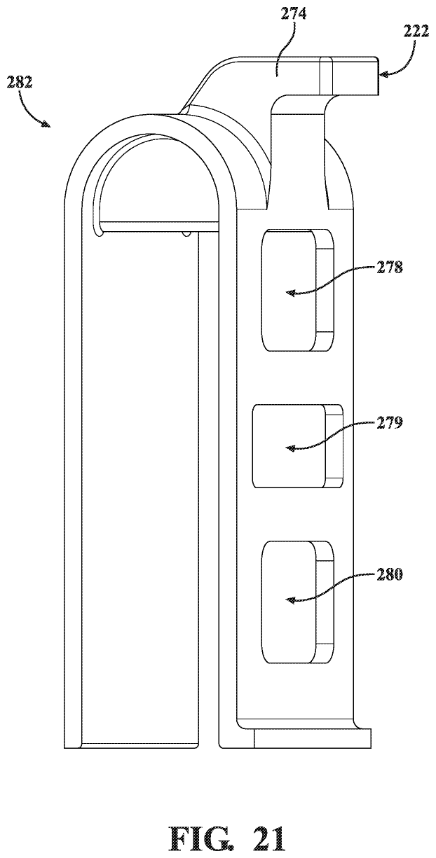

FIGS. 19 and 20 illustrate a partial view the fastener 210 in an engaged position in an assembly (the bottom portion of the locating extension 284 is not illustrated). In this example, the receiving mount 212 is integral with the workpiece 282. As such, the workpiece 282 is formed with one or more features that are collectively referred to as the receiving mount 212. These one or more features are best illustrated in FIG. 21, which is an isolated view of the workpiece 282 of FIGS. 19 and 20. These features cooperate with the fastener 210 to perform the function of (1) locating the fastener 210 relative to the workpiece 282; (2) securing the fastener 210 to the workpiece 282; and (3) engaging the engagement surface 230 of the body 218.

Referring now to FIG. 19, a perspective view of the fastener 210 including the housing 214 defining the cavity 216, and the body 218 slidably disposed in the cavity 216 is illustrated. In FIG. 19, the fastener 210 is in an engaged position in which the indicia element 220 is visible in the window 226 to indicate an assembly status of the fastener 210.

The receiving mount 212 is integral with the workpiece 282 and comprises the push surface and 3 apertures. In this example, the receiving mount 212 includes a push surface 222 that is defined by an extension 274, a first aperture 278, a second aperture 279, and a third aperture 280 to properly locate the housing 214. FIG. 20 is a cross-sectional view of the fastener 210 of FIG. 19 along line 20-20, which illustrates the receiving mount 212 having the push surface 222 formed by the extension 274. The push surface 222 of this example being formed by a single, continuous surface created by the extension 274. As such, the extension 274 defines an unbroken push surface 222 (not segmented like in the previous example with two ribs).

The cross-sectional view of the fastener 210 illustrated in FIG. 20 shows the receiving mount 212 including the first, second, and third apertures 278, 279, 280 and the housing 214 including the locating extension 284 having the first clip 286, the locating post 287, and a second clip 288, which are engaged in the first, second, and third apertures 278, 279, 280 to locate the housing 214 relative to the workpiece 282. As previously explained, the clips can be a canoe clip, pine tree clip, push pin or other structure that can project through a hole in a panel and adequately grip the panel to secure the fastener 210 to the workpiece 282.

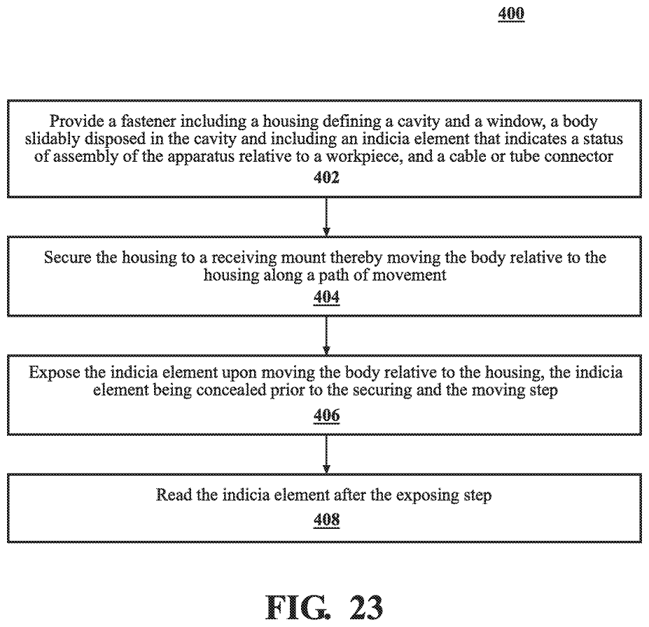

Referring again to FIG. 19, the fastener 210 includes (1) the housing 214; (2) the locating extension 284 having the first clip 286, the locating post 287, the second clip 288, and routing liner 290 (only one of the two routing liners is illustrated). The routing liner 290 is formed separately and at least partially defines one or more routing orifices 296; and (3) a harnessing portion 294, which mechanically engages the locating extension 284 and cooperates with a third routing liner 298 to fully define the two routing channels or routing orifices 296. In this example, the third routing liner 298 is over molded into the harnessing portion 294, but could be co-molded, welded, adhered to, or mechanically fixed to the harnessing portion 294 in other examples. The routing liners 290, 298 in this example are formed separately from the locating extension 284 and the harnessing portion 294 of the fastener 210 to impart various properties on the portions of the fastener 210 that define the routing channels 296. The material used to form the routing liners can be designed or selected to provide extra durability, lubricity, thermal or electrical insulation properties, etc. In FIG. 23, the two routing channels 296 have exemplary wires or cables routed therethrough.

In another example, a routing fastener includes a receiving mount having a push surface. The fastener also includes a housing. The housing defines an opening and an aperture, and includes a top wall, a bottom wall opposite of the top wall, and a stop opposite the opening. The fastener also includes a body. The body is slidably disposed in the aperture and includes an engagement surface, a biasing surface, and an indicia element that indicates a status of assembly of the fastener relative to the workpiece. A biasing element configured to bias the body away from the stop and towards the opening. The body is movable in the aperture between a concealed mode in which the indicia element is not visible and an exposed mode in which the indicia element is exposed to the environment, where the housing must properly engage the receiving mount to move the body and indicia element thereon into the exposed mode. A user cannot expose the indicia element when the housing is not properly secured to the workpiece due to the housing interfering with movement of the body.

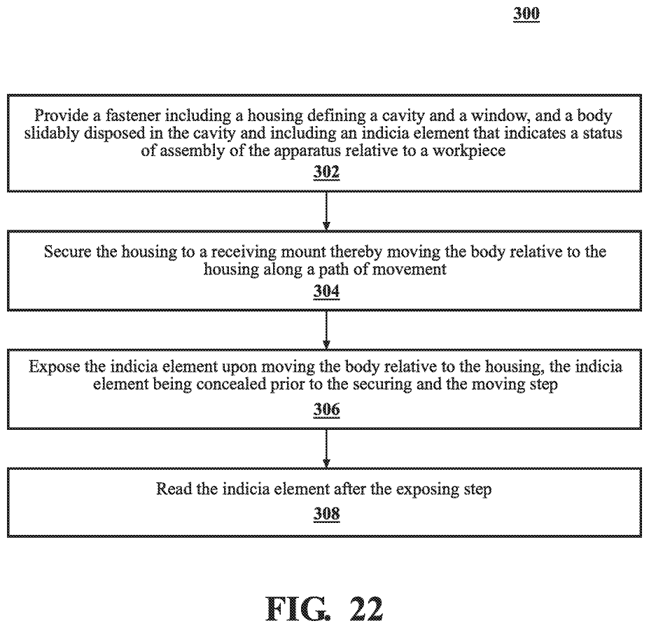

Referring now to FIG. 22, a method of using an indicative fastener is disclosed and shown at 300. As described above, the fastener is provided 302 and includes the housing defining the cavity and the window, the body slidably disposed in the cavity and including the indicia element that indicates a status of assembly of the apparatus relative to the workpiece, and a part or assembly. The method may include the step of inserting the receiving mount into an aperture in the workpiece (not illustrated). The method may also include the step of biasing the body away from the stop and towards the opening along the path of movement such that when the housing is not secured to the receiving mount the indicia element is concealed (not illustrated). The housing is secured to the receiving mount and thereby moves the body relative to the housing along a path of movement 304. The indicia element is exposed in the window upon moving the body relative to the housing, the indicia element being concealed prior to the moving step 306. Once exposed, the indicia element is read 308.

In some examples, the indicative fastener is used with a cable routing or tube routing assembly. Referring now to FIG. 23, a method of using the fastener with a cable or tube routing assembly is also disclosed and shown at 400. As described above, the cable or tube routing apparatus is provided 402 and includes the housing defining the cavity and the window, the body slidably disposed in the cavity and including the indicia element that indicates a status of assembly of the apparatus relative to the workpiece, and the cable or tube connector. The method may include the step of inserting the receiving mount into an aperture in the workpiece (not illustrated). The method may also include the step of biasing the body away from the stop and towards the opening along the path of movement such that when the housing is not secured to the receiving mount the indicia element is concealed (not illustrated). The housing is secured to the receiving mount and thereby moves the body relative to the housing along a path of movement 404. The indicia element is exposed in the window upon moving the body relative to the housing, the indicia element being concealed prior to the moving step 406. Once exposed, the indicia element is read 408. It should be appreciated that the fastener disclosed and described herein has been developed for various parts and assemblies and is not limited to routing applications.

When properly attached to the workpiece the indicia element transitions from a concealed mode to an exposed mode. In this exposed mode, the indicia element can be exposed. Previously, the indicia element was concealed. The indicia element then can be viewed or read by the user or a device to confirm proper installation of the part, e.g., cable routing fastener, relative to the workpiece. The data associated with this reading or viewing can be transmitted to, logged, recorded, uploaded and/or sent to a computer, network, server, or other storage medium or device to confirm the proper installation of the fastener. With the fastener properly installed, a user can use the connector, which again can be a zip tie, clip, hook and loop fastener, clamp, C-clip, cord, band, or other type of fastener to, in some examples, secure a cable or tube to the fastener in the predetermined location dictated by the fastener. With this activity complete, the cable or tube can extend in a proper orientation configuration within the space adjacent the workpiece.

Directional terms, such as “vertical,” “horizontal,” “top,” “bottom,” “upper,” “lower,” “inner,” “inwardly,” “outer” and “outwardly,” are used to assist in describing the invention based on the orientation of the examples shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current examples of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all examples of the invention or to limit the scope of the claims to the specific elements illustrated or described in connection with these examples. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed examples include a plurality of features that are described in concert and that might cooperatively provide a collection of benefits. The present invention is not limited to only those examples that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

1. A fastener configured to engage a receiving mount including a push surface, the fastener comprising:
a housing defining a longitudinal axis, an opening, a cavity, and a window, the housing including a stop opposite the opening and a holding element; and
a body slidably disposed in the cavity and including an engagement surface, a retaining element, a biasing element, and an indicia element configured to indicate an assembly status of the fastener;
wherein the biasing element is configured to bias the body away from the stop and towards the opening along the longitudinal axis;
wherein the holding element of the housing cooperates with the retaining element of the body to retain the body in the housing when the fastener is in an assembled state;
wherein the body is movable in the cavity between a disengaged position in which the indicia element is not visible in the window and an engaged position in which the indicia element is visible in the window to indicate an assembly status of the fastener; and
wherein when the push surface of the receiving mount contacts the engagement surface of the body to move the body within the cavity from the disengaged position to the engaged position and expose the indicia element in the window and indicate that the fastener is properly attached to a workpiece.

2. The fastener of claim 1 further including a locating extension extending from the body including one or more connectors and optionally a locator.

3. The fastener of claim 1 further including at least one connector that is configured to engage the receiving mount to locate and secure the housing relative to the workpiece.

4. The fastener of claim 3 wherein the connector is one or more clips configured to engage one or more apertures on the workpiece.

5. The fastener of claim 1 further including at least one locator that cooperates with the receiving mount to locate and secure the housing relative to the workpiece.

6. The fastener of claim 5 wherein the at least one locater is a pin configured to engage an aperture on the workpiece.

7. The fastener of claim 1 wherein the housing includes an end wall that defines the stop.

8. The fastener of claim 1 wherein the biasing element is positioned between a biasing surface of the body and the stop of the housing.

9. The fastener of claim 8 wherein the biasing element comprises 1 or more resilient arms or a resilient loop.

10. The fastener of claim 1 wherein the retaining element includes a first clasp and a second clasp and the holding element comprises a first notch and a second notch.

11. The fastener of claim 1 wherein the body includes a first surface with the indicia element thereon, a second surface opposite the first surface, and a pair of side surfaces.

12. The fastener of claim 11 wherein the body includes a guide extending from the second surface.

13. The fastener of claim 12 wherein the housing includes a bottom wall, a top wall defining the window opposite the bottom wall, a first sidewall, and a second sidewall opposite the first sidewall.

14. The fastener of claim 13 wherein the bottom wall defines a receiving slot wherein when the housing is engaged with the receiving mount and the push surface of the receiving mount is aligned with and contacts the engagement surface of the body, a guide moves within the receiving slot to guide movement of the body.

15. The fastener of claim 13 wherein:
the bottom wall of the housing comprises an attachment interface or a locating extension; and
a cable or tube routing apparatus and/or the workpiece is connected to the attachment interface or the locating extension.

16. The fastener of claim 1 wherein the indicia element comprises a machine-readable optical indicator.

17. A routing fastener is configured to engage a receiving mount including a push surface, the routing fastener comprising:
a housing defining an opening, an aperture, and including a top wall, a bottom wall opposite of the top wall, and a stop opposite the opening; and
a body slidably disposed in the aperture and including an engagement surface, a biasing surface, and an indicia element that indicates a status of assembly of the routing fastener relative to a workpiece; and
a biasing element configured to bias the body away from the stop and towards the opening;
wherein the body is movable in the aperture between a concealed mode in which the indicia element is not visible and an exposed mode in which the indicia element is visible,
wherein the housing must properly engage the receiving mount to move the body and indicia element thereon into the exposed mode, whereby a user cannot expose the indicia element when the housing is not properly secured to the receiving mount.

18. A method of using a fastener configured to engage a receiving mount, the method comprising:
providing the fastener including a housing defining a cavity and a window, a body slidably disposed in the cavity and including an indicia element that indicates a status of assembly of the fastener relative to a workpiece, and a connector;
securing the housing to the receiving mount and thereby moving the body relative to the housing along a path of movement;
exposing the indicia element in the window upon moving the body relative to the housing, the indicia element being concealed prior to the moving step; and
reading the indicia element after the exposing step.

19. The method of claim 18 wherein the housing further defines an opening and includes a stop opposite the opening, the method further comprising the step of biasing the body away from the stop and towards the opening such that when the housing is not secured to the receiving mount the indicia element is concealed.

20. The method of claim 19 further comprising applying force to the fastener so that:
a push surface of the receiving mount contacts an engagement surface of the body to move the body within the cavity from a disengaged position to an engaged position and expose the indicia element in the window to indicate that the fastener is properly installed on the workpiece; and
one or more connectors on the fastener engage with the workpiece.
